(19) United States
(12) Patent Application Publication
(10) Pub. No.: US 2011/0009780 A1
(43) Pub. Date: Jan. 13, 2011

(54) MUSCLE STRETCHING STRUCTURE FOR A FOOT MASSAGER

(75) Inventor: Yuan-Chuen Chen, Wai Zhong Village (TW)

Correspondence Address: Yen Jung Sung, 30-47 37 St., Astoria, NY, 11103, US

(73) Assignee: HSIN HAO HEALTH MATERIALS CO., LTD., Fan She Village (TW)

(21) Appl. No.: 12/501,488

(22) Filed: Jul. 13, 2009

(51) Int. Cl. A61H 19/00

(52) U.S. Cl. 601/100

(57) ABSTRACT

A muscle stretching structure for a foot massager includes a massaging base, two rocking boards, a first supporting element and a second supporting element. The massaging base has two bottom spaces, a first supporting surface and a second supporting surface, and a lifting unit disposed on each first supporting surface. Furthermore, a bottom side of each rocking board is attached to a respective rocking module. The first supporting element has two containment spaces and is pivoted to the first supporting surface of the massaging base with the first hinges. A second supporting element has two upper spaced and a driving unit is attached to the bottom of the second supporting element. The driving unit is disposed between the second supporting element and the second hinges. The rocking board can be rocked by the rocking module to perform a stretching movement upon the feet, and the first supporting element and the second supporting element are driven by the lifting unit and the driving unit to rotate in a direction opposite to the rocking direction of the rocking board so that the user's leg muscles are treated to both massaging and stretching effects.

### BACKGROUND OF THE INVENTION

1. Field of the Invention

The present invention relates to a massager, and, more particularly, to a muscle stretching structure for a foot massager, which has a rocking board that can be rocked by a rocking module to perform a stretching movement to the sole of the foot, and a first supporting element and a second supporting element driven by a lifting unit and a driving unit to rotate in a direction opposite to the rocking direction of the rocking board so that the user's leg muscles and tendons are treated with both massaging and stretching effects.

2. Description of the Related Art

Usually, after long time periods of standing up, or walking, running, or bicycling exercises, a user's leg muscles suffer fatigue, which may cause muscle soreness or muscular tightness. Typical treatments for muscular pain are hot water baths or legs massages. A prior art leg massager utilizes airbags or massaging balls to push against a user's legs for massage treatment purposes. With different designs, the massager can provide pinching, pressing, and vibrating effects. However, these different massage treatments only relax the user and do not relieve muscular tightness.

Therefore, it is desirable to provide a muscle stretching structure for a foot massager so that the user's leg muscles and tendons are provided both massaging and stretching effects to mitigate and/or obviate the aforementioned problems.

### SUMMARY OF THE INVENTION

A main objective of the present invention is to provide a muscle stretching structure for a foot massager that both massages and stretches the leg muscles and tendons of a user.

In order to achieve the objective, the muscle stretching structure for a foot massager of the present invention comprises: a massaging base, two rocking boards, a first supporting element

A muscle stretching structure for a foot massager comprises: a massaging base, two rocking boards, a first supporting element and a second supporting element. The massaging base has two bottom spaces, a first supporting surface extending from left and right sides of the bottom space, and a lifting unit disposed on each first supporting surface. Furthermore, a second supporting surface is on the top end of the massaging base; two rocking boards each have a pivot at a center position, and a bottom side of each rocking board is attached to a respective rocking module. The rocking module comprises two alternating inflatable bellows. The first supporting element further comprises two containment spaces corresponding to the bottom spaces of the massaging base. A plurality of first hinges are securely attached to the front end of the bottom of the first supporting element. The second supporting element has two upper spaces corresponding to the containment spaces, and the bottom of the second supporting element has a plurality of the driving units. The driving units are disposed between the second supporting element and the second hinges. The second hinges respectively have a counter-clockwise rotating button and a clockwise rotating button to control clockwise and counter-clockwise rotation of the second supporting element, and the counter-clockwise rotating button is connected to the front end of the bottom of the second supporting element. The lifting unit and the driving unit are inflatable bellows. The bottom space, the containment space and the upper space are placed in-line to form a massaging section, and the inside face of the massaging section has a plurality of massage airbags.

Each rocking board is pivotably connected to a respective bottom space of the massaging base 10 by the pivot, and the bottom side of each rocking board is attached to a respective rocking module. The first supporting element is pivoted to the first supporting surface of the massaging base with the first hinges, and the lifting unit is installed between the first supporting element and the first supporting surface. Therefore, the first supporting element can rock forward with the first hinges, and the bottom of the second supporting element is locked with the counter-clockwise rotating button of the second hinges. Furthermore, the clockwise rotating button of the second hinges is secured with the second supporting surface of the massaging base, and the driving unit is installed between the second supporting element and the second hinges. Additionally, the counter-clockwise rotating button and the clockwise rotating button of the second hinges can be rotated to cause the second supporting element to rock forward and backward.

The first rocking module below the rocking board generates an alternating lifting movement to make the rocking board rotate clockwise and counterclockwise around the pivot, and the sole of the user's feet is completely pressed against the rocking board due to the clamping force provide by the massage airbags in the bottom space. Therefore, the toe side of the soles are pressed down and the ankle sides of the soles are pulled up; or the toe side of the soles are pulled up and the ankle sides of the soles are pressed down, which performs a stretching movement upon the user's soles. Furthermore, with the first supporting element, the lifting unit below the first supporting element generates a lifting force, and the massage airbags in the containment space clamp the calf section of the user's legs. The first supporting element is pivoted upward with the first hinges, and the soles remain held on the rocking board so that the first supporting element can stretch the user's legs by pulling the calf section in a direction away from the soles. The second supporting element utilizes the massage airbag in the upper space to clamp the upper legs of the user's legs, and the driving unit is disposed between the second supporting element and the second hinges. When the driving unit pushes against the second supporting element, the second supporting element rocks upward from the counter-clockwise rotating button; with the pressure applied on the soles, the second supporting element clamps the upper legs and provides a movement away from the sole end to achieve the stretching effect between the soles and the knees.

With the above-mentioned embodiment, the rocking board can be rocked by the rocking module to perform a stretching movement upon the feet, and the first supporting element and the second supporting element are driven by the lifting unit and the driving unit to rotate in a direction opposite to the rocking direction of the rocking board so that the user's leg muscles are treated to both massaging and stretching effects.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of the present invention.

FIG. 2 is an exploded perspective view of the present invention.

FIG. 3 is a cross-sectional drawing from a side view of the present invention.

FIG. 4 is a schematic drawing of a stretching movement according to the present invention.

FIG. 5 is another schematic drawing of a stretching movement according to the present invention.

FIG. 6 is a cross-sectional drawing from a front view of a massage airbag of the present invention.

FIG. 7 is a schematic drawing of the usage of operation the present invention.

### DETAILED DESCRIPTION OF THE PREFERRED EMBODIMENT

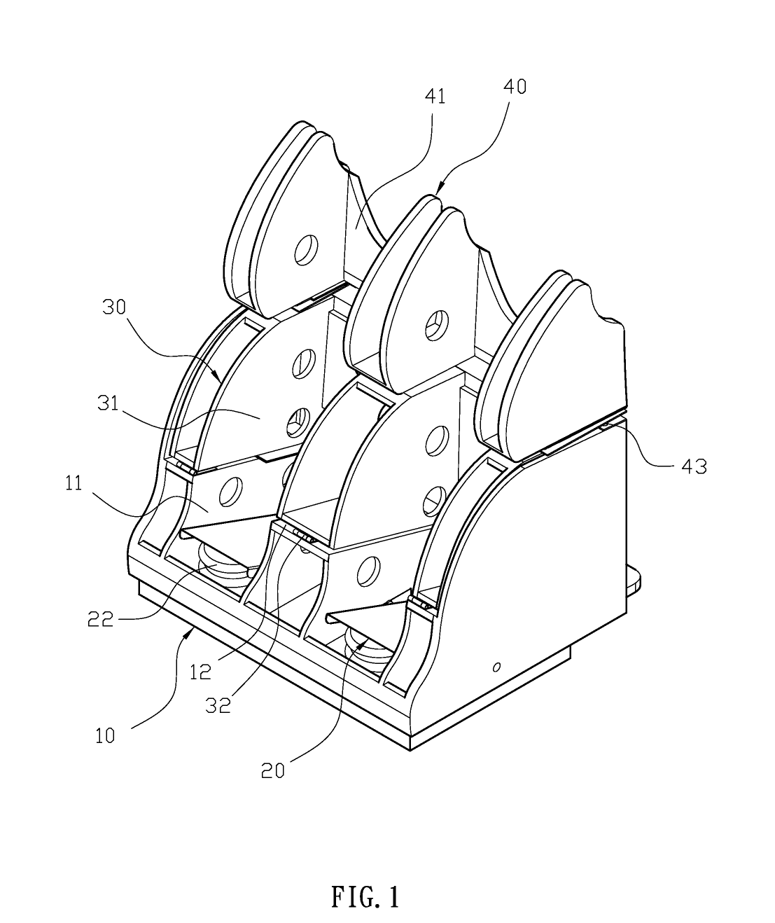

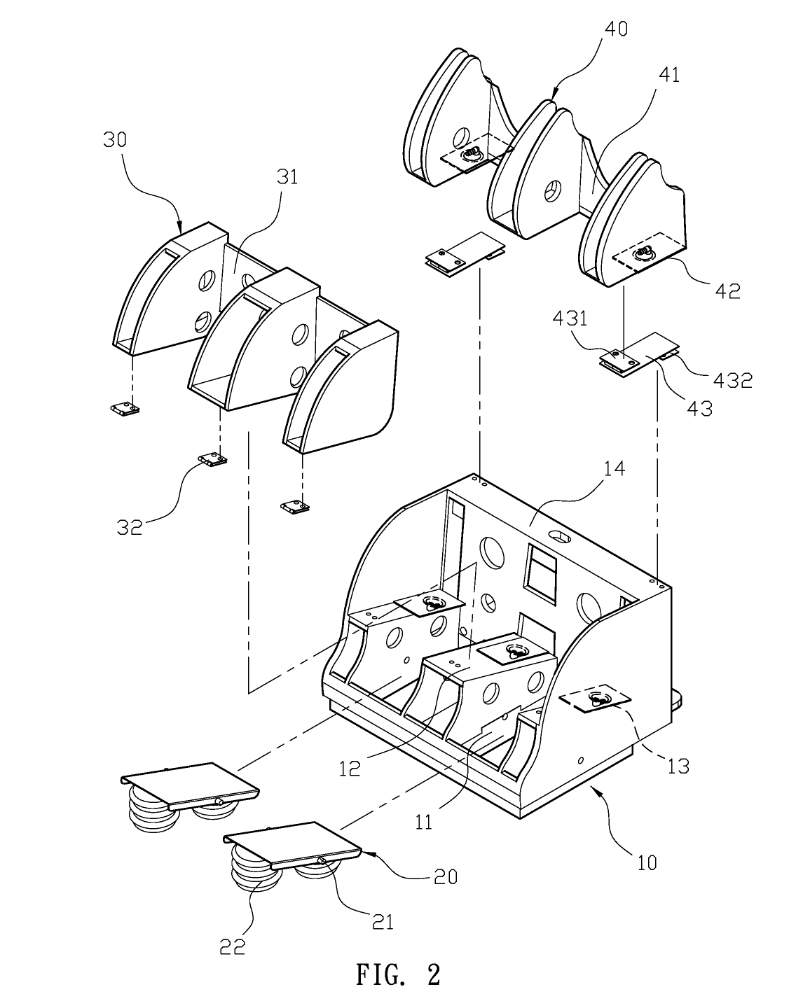

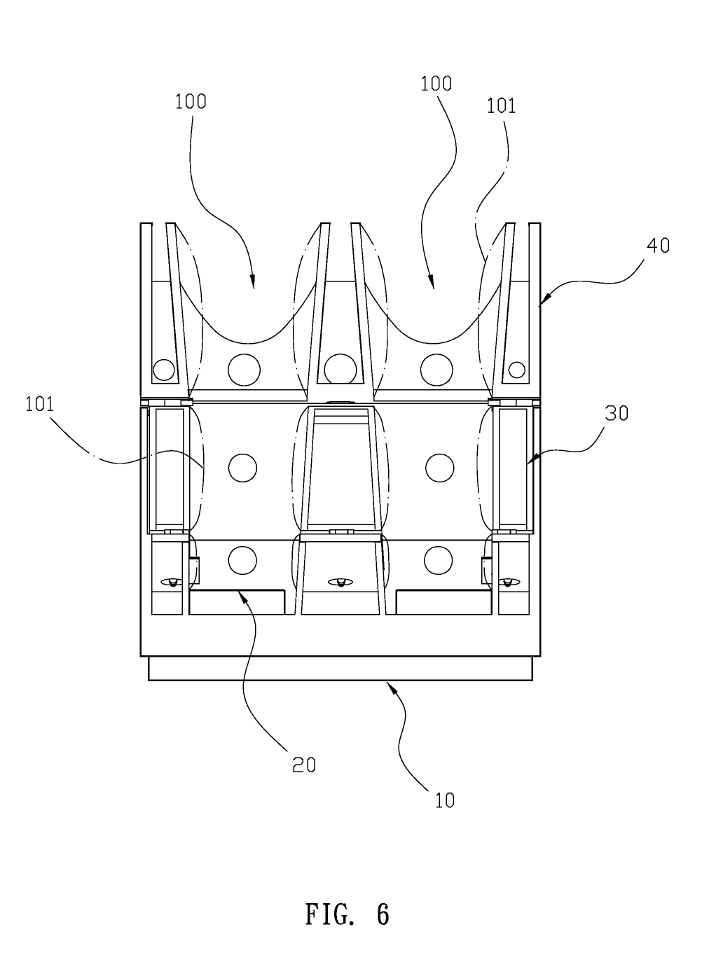

Please refer to both FIG. 1 and FIG. 2. FIG. 1 is a perspective view of the present invention. FIG. 2 is an exploded perspective view of the present invention. A muscle stretching structure for a foot massager comprises: a massaging base 10, two rocking boards 20, a first supporting element 30 and a second supporting element 40. The massaging base 10 has two bottom spaces 11, a first supporting surface 12 extending from left and right sides of the bottom space 11, and a lifting unit 13 disposed on each first supporting surface 12. Furthermore, a second supporting surface 14 is on the top end of the massaging base 10; two rocking boards 20 each have a pivot 21 at a center position, and a bottom side of each rocking board 20 is attached to a respective rocking module 22. The rocking module 22 comprises two alternatingly inflatable bellows. The first supporting element 30 further comprises two containment spaces 31 corresponding to the bottom spaces 11 of the massaging base 10. A plurality of first hinges 32 are securely attached to the front end of the bottom of the first supporting element 30. The second supporting element 40 has two upper spaces 41 corresponding to the containment spaces 31, and the bottom of the second supporting element 40 has a plurality of the driving units 42. The driving units 42 are disposed between the second supporting element 40 and the second hinges 43. The second hinges 43 respectively have a counter-clockwise rotating button 431 and a clockwise rotating button 432 to control clockwise and counter-clockwise rotation of the second supporting element 40, and the counter-clockwise rotating button 431 is connected to the front end of the bottom of the second supporting element 40. The lifting unit 13 and the driving unit 42 are inflatable bellows. As shown in FIG. 6, the bottom space 11, the containment space 31 and the upper space 41 are placed in-line to form a massaging section 100, and the inside face of the massaging section 100 has a plurality of massage airbags 101.

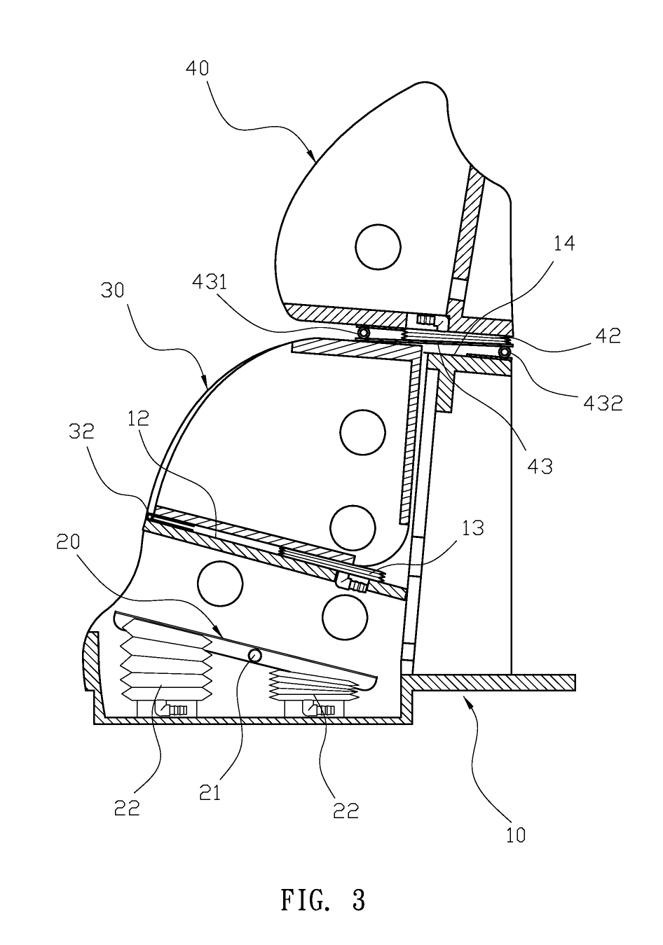

Please refer to FIGS. 1, 2, 3 again for the massager structure. Each rocking board 20 is pivotably connected to a respective bottom space 11 of the massaging base 10 by the pivot 21, and the bottom side of each rocking board 22 is attached to a respective rocking module 22. The first supporting element 30 is pivoted to the first supporting surface 12 of the massaging base 10 with the first hinges 32, and the lifting unit 13 is installed between the first supporting element 30 and the first supporting surface 12. Therefore, the first supporting element 30 can rock forward with the first hinges 32, and the bottom of the second supporting element 40 is locked with the counter-clockwise rotating button 431 of the second hinges 43. Furthermore, the clockwise rotating button 432 of the second hinges 43 is secured with the second supporting surface 14 of the massaging base 10, and the driving unit 42 is installed between the second supporting element 40 and the second hinges 43. Additionally, the counter-clockwise rotating button 431 and the clockwise rotating button 432 of the second hinges 43 can be rotated to cause the second supporting element 40 to rock forward and backward.

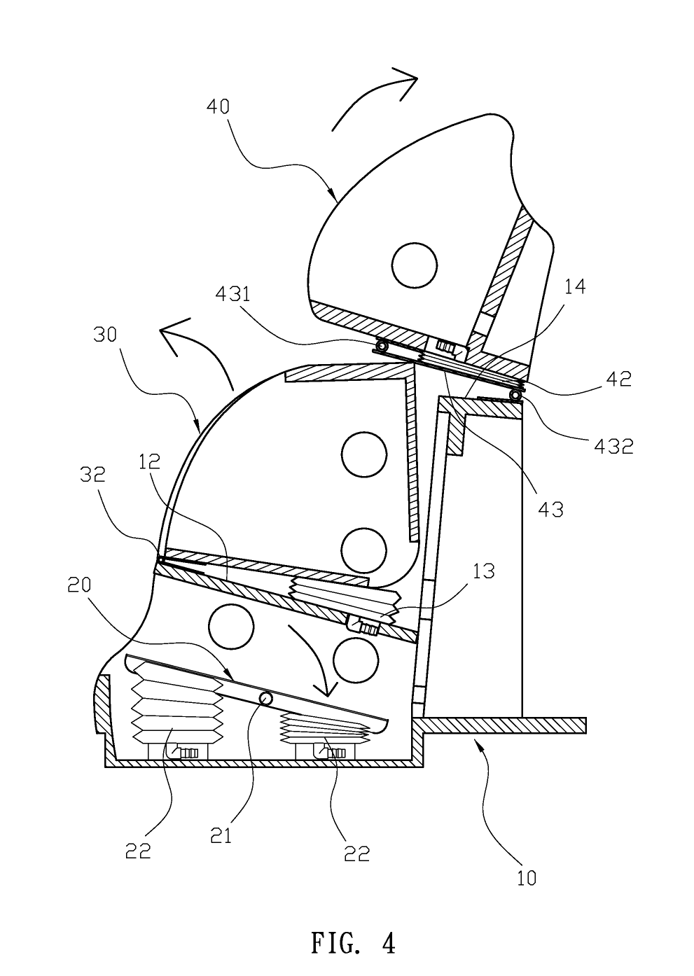

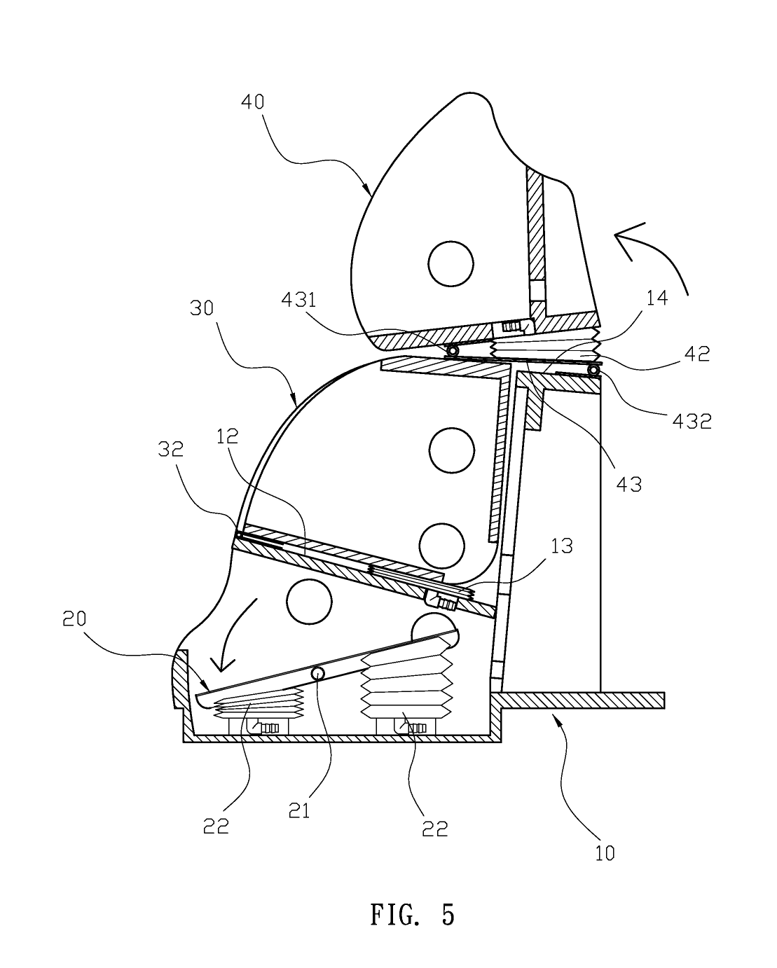

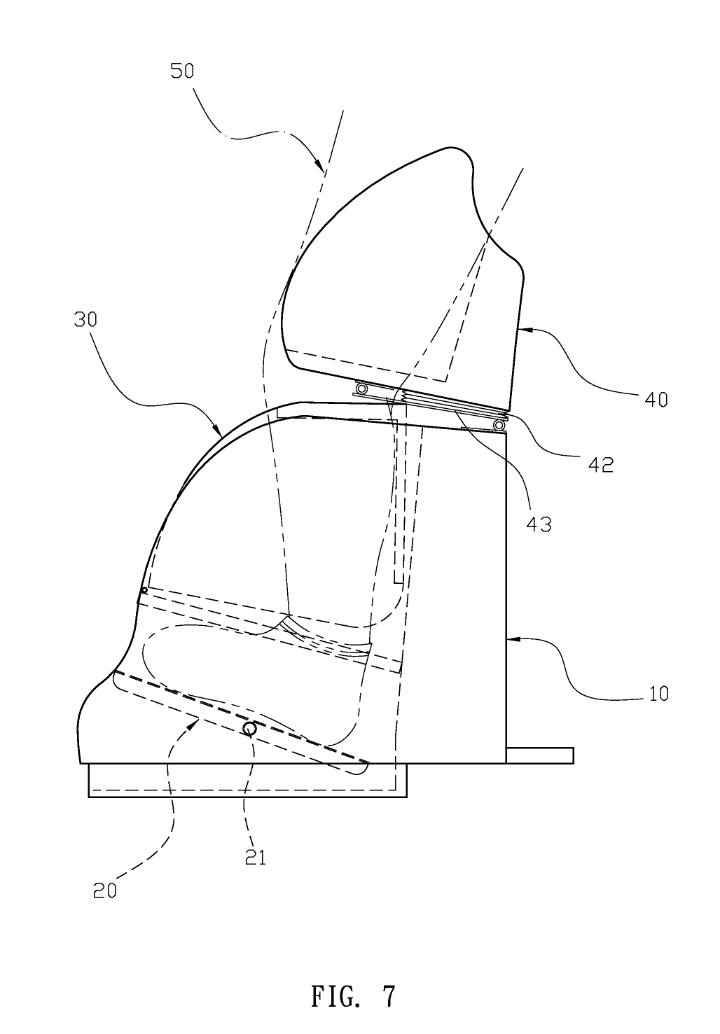

For actual movement, please refer to FIGS. 4, 5, 6 with reference to FIG. 2. The massaging base 10, the first supporting element 30 and the second supporting element 40 respectively have the bottom space 11, the containment space 31 and the upper space 41, and the bottom space 11, the containment space 31 and the upper space 41 are all in-line to form the massaging section 100. When a user place his or her legs 50 in the massaging section 100, as shown in FIG. 7, the user's feet are placed in the bottom spaces 11 and the user's sole step onto the rocking board 20; the user's calves are placed in the containment space 31 of the first supporting element 30, and the upper legs are placed in the upper space 41 of the second supporting element 40. The massage airbags 101 disposed in the massaging section 100 are all able to inflate and squeeze the user's legs 50 to provide a proper massage. For the stretching movement, the first rocking module 22 below the rocking board 20 generates an alternating lifting movement to make the rocking board 20 rotate clockwise and counterclockwise around the pivot 21, and the sole of the user's feet is completely pressed against the rocking board 20 due to the clamping force provide by the massage airbags 101 in the bottom space 11. Therefore, the toe side of the soles are pressed down and the ankle sides of the soles are pulled up; or the toe side of the soles are pulled up and the ankle sides of the soles are pressed down, which performs a stretching movement upon the user's soles. Furthermore, with the first supporting element 30, the lifting unit 13 below the first supporting element 30 generates a lifting force, and the massage airbags 101 in the containment space 31 clamp the calf section of the user's legs 50. The first supporting element 30 is pivoted upward with the first hinges 32, and the soles remain held on the rocking board 20 so that the first supporting element 30 can stretch the user's legs by pulling the calf section in a direction away from the soles. The second supporting element 40 utilizes the massage airbag 101 in the upper space 41 to clamp the upper legs of the user's legs 50, and the driving unit 42 is disposed between the second supporting element 40 and the second hinges 43. When the driving unit 42 pushes against the second supporting element 40, the second supporting element 40 rocks upward from the counter-clockwise rotating button 431; with the pressure applied on the soles, the second supporting element 40 clamps the upper legs and provides a movement away from the sole end to achieve the stretching effect between the soles and the knees.

With the above-mentioned embodiment, the rocking board 20 can be rocked by the rocking module 22 to perform a stretching movement upon the feet, and the first supporting element 30 and the second supporting element 40 are driven by the lifting unit 13 and the driving unit 42 to rotate in a direction opposite to the rocking direction of the rocking board 20 so that the user's leg muscles are treated to both massaging and stretching effects.

Although the present invention has been explained in relation to its preferred embodiment, it is to be understood that many other possible modifications and variations can be made without departing from the spirit and scope of the invention as hereinafter claimed.

What is claimed is:

1. A muscle stretching structure for a foot massager comprising:
a massaging base;
at least two rocking boards;
a first supporting element; and
a second supporting element;
wherein the massaging base has at least two bottom spaces, the at least two rocking boards each having a pivot at a center position and pivotably connected to a respective bottom space of the massaging base, and a bottom side of each rocking board attached to a respective rocking module;
and wherein each rocking module disposed below the rocking board generates an alternating lifting movement on each end of the rocking board such that the rocking board rotates clockwise and counterclockwise around the pivot, and soles of a user's feet are held by a massage airbag in each bottom space.

2. The muscle stretching structure for a foot massager as claimed in claim 1, wherein the rocking module comprises two alternating inflatable bellows.

3. The muscle stretching structure for a foot massager as claimed in claim 1, wherein the massaging base further comprises a first supporting surface extending from left and right sides of the bottom space, a lifting unit is disposed on each first supporting surface, and the first supporting element further comprises two containment spaces corresponding to the bottom spaces of the massaging base.

4. The muscle stretching structure for a foot massager as claimed in claim 3, wherein a plurality of first hinges are securely attached to the front end of the bottom of the first supporting element, and the first supporting element is pivoted to the first supporting surface of the massaging base with the first hinges.

5. The muscle stretching structure for a foot massager as claimed in claim 3, wherein the lifting unit has at least one inflatable bellows.

6. The muscle stretching structure for a foot massager as claimed in claim 1, wherein a second supporting surface is on the top end of the massaging base, and the bottom of the second supporting element is pivoted to the second supporting surface of the massaging base with at least two second hinges.

7. The muscle stretching structure for a foot massager as claimed in claim 6, wherein the second hinges respectively have a counter-clockwise rotating button and a clockwise rotating button to control clockwise and counter-clockwise rotation of the second supporting element.

8. The muscle stretching structure for a foot massager as claimed in claim 7, wherein the counter-clockwise rotating button of the second hinges is secured with the bottom of the second supporting element, and the clockwise rotating button of the second hinges is secured with the second supporting surface of the massaging base.

9. The muscle stretching structure for a foot massager as claimed in claim 1, wherein the second supporting element has two upper spaces corresponding to the containment spaces, and the bottom of the second supporting element has a plurality of the driving units.

10. The muscle stretching structure for a foot massager as claimed in claim 9, wherein the driving units comprise at least one inflatable bellows.
